(19) United States
(12) Patent Application Publication
(10) Pub. No.: US 2022/0234919 A1
(43) Pub. Date: Jul. 28, 2022

(54) IRON-COMPRISING CONCENTRATE FOR PREPARATION OF IN SITU REMEDIATION SOLUTION

(71) Applicant: Höganäs AB (Publ), Höganäs (SE)

(72) Inventors: Madan TANDUKAR, Cary, NC (US); Hyunshik CHANG, Cary, NC (US); Carolyn HAWKINS, Cary, NC (US); Benjamin MORK, Tustin, CA (US)

(73) Assignee: Höganäs AB (Publ), Höganäs (SE)

(21) Appl. No.: 17/157,327

(22) Filed: Jan. 25, 2021

(51) Int. Cl. C02F 1/70; B01J 20/02

(52) U.S. Cl. CPC C02F 1/705; C02F 2103/06; B01J 2220/46; B01J 20/0229

(57) ABSTRACT

A liquid concentrate composition for remediation of groundwater, said composition consisting of powdered iron in the amount of 30 to 70% zero-valent iron powder, such as 40 wt, 1 to 15 wt % of water, 0.1 to 1.5% of surfactant and 40 to 70 wt % of the organic carrier, wherein the organic carrier is added to the 100 wt % and optionally, organic electron donor solution and/or remediation chemical, wherein organic electron donor solution and/or remediation chemical is not exceeding 10 wt % of the liquid concentrate.

### TECHNICAL FIELD OF THE INVENTION

The present disclosure relates generally to the field of groundwater and soil remediation. More particularly, the disclosure relates to a stable iron-comprising suspension for preparation of groundwater remediation solution.

### DESCRIPTION

### Background

In situ groundwater remediation is often performed by injection of treatment chemicals into contaminated aquifers (groundwater-saturated soil). Soluble treatment chemicals, such as sodium permanganate, can be dissolved completely into water and easily pumped into a contaminated site. Several technologies have been developed to destroy toxic contaminants in the groundwater.

Several compositions and methods have been developed over the years for the purpose of eliminating toxic contaminants, such as chlorinated hydrocarbons from groundwater. Some methods involve zero valent metals, often zero valent iron, and method of adding the compositions into the contaminated groundwater. Metals serve as an electrochemical reductant and can react with and convert trichloroethylene and similar compounds into ethene and other innocuous substances. These reactions are relatively fast and when reacting with trichloroethylene and chlorinated ethenes the degradation pathway can bypass the formation of partially dechlorinated and toxic intermediaries such as vinyl chloride.

Solid-phase treatment chemicals, such as metal powders (Zero Valent Iron, ZVI), are useful for in-situ treatment, but are difficult to apply by in-situ injection due to their insoluble, particulate nature.

It is therefore useful to develop improvements to the injection transport of ZVI particles for in-situ remediation. Improving transport results in better contact with dispersed contaminants, lower application costs (fewer injection points), and overall better results for site cleanup.

This invention improves the distribution (transport) of small iron particles through groundwater and soil upon injection for in-situ groundwater remediation.

### Description

It is disclosed herein a liquid concentrate composition for remediation of groundwater, said composition consisting of powder iron in the amount of 30 to 50% zero-valent iron powder, such as about 40 wt %; 1 to 15 wt % of water; 0.1 to 1.5% of surfactant and 40 to 70 wt % of the organic carrier, wherein the organic carrier is added to the 100 wt % and optionally, organic electron donor solution and/or remediation chemical, wherein organic electron donor solution and/or remediation chemical is not exceeding 10 wt % of the liquid concentrate.

The liquid concentrate composition according to the invention a slurry of a zero valent iron. The composition can be easily transported and diluted on site to the desired iron concentration. The composition is for remediation of groundwater and is useful in destroying toxic contaminants in groundwater and soil by injection into aquifers.

The powder iron (a zero valent iron) is present in the composition in the amount of between 30 wt % and 50 wt %, preferably between 38 wt % and 43 wt %. In a preferable embodiment the amount of powder zero valent iron is about 40 wt %.

It is further disclosed that the minor amount of water is added to the composition. The water added is in the amount between 11 to 15 wt % of water; preferably between 8 and 12 wt %. It is important that the water amount does not exceed 20 wt % in order for liquid concentrate to be a slurry.

In accordance with the disclosure the liquid concentrate composition further comprises 0.1 to 1.5% of surfactant.

Surfactant can be selected from but not limited to non-ionic and anionic surfactants.

In accordance with the disclosure the liquid concentrate composition further comprises the organic carrier. The organic carrier shall be non-toxic and water miscible. The organic carrier may be selected from but not limited to glycerol, propylene glycol, polyethylene glycols.

The organic carrier is added such that it comprises 40 to 70 wt % to the liquid concentrate composition. In some preferable embodiments the organic carrier is between 45 wt % and 55 wt % of the liquid concentrate. The organic carrier is added up to 90 wt % or 100 wt %.

Optionally, organic electron donor solution and/or remediation chemical, can be added to the composition such that organic electron donor solution and/or remediation chemical is not exceeding 10 wt % of the liquid concentrate.

Organic electron donor is an organic compound designed to biodegrade naturally and stimulate anaerobic biodegradation of halogenated contaminants. Examples of suitable electron donors include Ethyl lactate and vegetable oils such as soybean oil.

In contrast to prior art existing such as iron powder slurries in water, or simple iron powder concentrates in glycerol, the liquid concentrate in accordance with the invention is easily transported and has superior properties when diluted to a ready-to-use solution. A benefit of the present invention is that when mixed and diluted with water at the point of use, the injected iron particulates transport further through groundwater and soil than simple iron slurries. Further transport of ZVI particles upon injection results in easier application, better contact with contaminants, and reduced time and cost for the injection process.

Without any wish to be bound to any theory the inventors speculate that the water and/or surfactants present in the invention modify the surface of iron powder particles such that they have less affinity for soil particles and more affinity for the liquid water phase. This would have the benefit of reducing interaction with soil particles.

The surfactant can be an anionic or nonionic surfactant. The benefits of such surfactants are to improve dispersion of the solid iron particles, preventing them from agglomerating and minimizing their interactions with soil particles in use.

Preferably, anionic surfactant is an alkali metal salt of a long-chain carboxyl or sulfonic acids.

Preferably, the non-ionic surfactant is a sorbitan ethoxylate, such as Polysorbate 20 or Polysorbate 80.

The organic carrier may be selected from propylene glycol or glycerol, but other organic carriers are not excluded.

In accordance with another embodiment of the invention liquid concentrate has a viscosity between 2000 and 5000 cp as measured at 6 RPM with a Brookfield DV1 viscometer (spindle #2) at a temperature of 20 degrees C.

The method for measuring viscosity was that a pint container was filled with 500 mL of a sample. The spindle was then lowered into the sample to the immersion groove of the spindle. The viscometer was turned on and the value was recorded after the dial reading settled. The reading was then multiplied by the factor for #2 spindle at 6 RPM, which is 50.

In accordance with the preferred embodiment the liquid concentrate has a specific gravity of about 1.8 g/mL determined by using a 83.2 mL BYK-Gardner PV-9654 specific gravity cup with 0.5% tolerance.

The specific gravity is measured as follows. The cup was placed on the scale and the scale was tared. Then the sample was filled to the brim of the cup. The lid was placed on the cup and the excess material that was pressed out of the cup was wiped away. The full weight of the cup was recorded. The recorded weight was divided by 10 to determine the lb/gal of the sample.

In the preferred embodiment the iron particles in the dispersion have average diameter between 1 and 10 microns as measured by laser light scattering method.

In accordance with another aspect it is disclosed a method for preparation of a ready-to use solution for injecting into the groundwater with the purpose of remediation, said method comprising: providing the liquid concentrate as described above, diluting with water such that the final concentration of iron in the solution is between 0.1 wt % and 5 wt %, such as 1 wt % or 2 wt %.

It shall be understood that all aspects relating to the composition are applicable in the method for preparation of a ready-to-use solution for injecting into the groundwater

### FIGURE LEGENDS

FIG. 1. Maximum injection pressure of each column (Column 1, Column 2 and Column 3) as disclosed below.

FIG. 2. Iron distribution by magnetic susceptibility measurement. Comparison of the control (black bars) with the invention (dotted bars).

### EXAMPLE COLUMNS

(1) Column 1: iron powder in water, —Comparative Sample 1
(2) Column 2: Invention, —Sample 2 According to the invention
(3) Column 3: iron powder in glycerol and water, Comparative Sample 3

### Example 1

Three plastic columns (4′ long by 2″ inner diameter) were loaded with water-saturated sand, taking precaution to avoid entrainment of air. Using a peristaltic pump, water was then flowed through each column at a flowrate of 260 mL/min, maintaining approximately 5 psi of pressure. For each test condition, the feed was then switched from water to the test sample while keeping the pumping rate constant. The test sample for Column 1 (Control) was a simple iron slurry consisting of 0.87% w/w iron powder in water. In Column 2, the present invention was tested at the same iron loading. In Column 3, a mixture of glycerol (1.3 wt %), water (97.83 wt %), and iron powder (0.87 wt %) was tested as a control for the presence of glycerol.

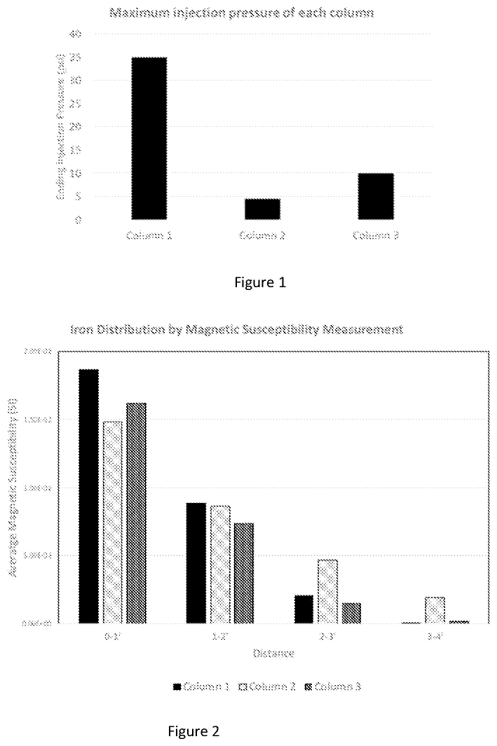

Pumping was continued for each sample for 10 minutes. While the injection pressure in Column 2 was consistent at approximately 5 psi, the pressure in the control column rose to near 35 psi, shown in FIG. 1, indicating some clogging by the simple iron slurry. Each feed was then switched back to water, and pumping continued for another 10 minutes. The columns were then sealed for further analysis. The collected eluents from the control Columns 1 and 3 were clear with no apparent presence of iron. Eluent from Column 2 was a dark-colored suspension, indicating the elution of iron particles.

Magnetic susceptibility measurements were made along the length of each column to determine the relative concentration of iron metal particles in the saturated sand. The magnetic susceptibility was measured using a Barrington MS2/MSC magnetic susceptibility meter. The measurements were taken at 1 inch intervals along the entire length of the column. The data, summarized in FIG. 2, indicate that the control sample deposited more iron in the first two feet of the column, while the invention transported significantly more iron particles to the 2-4 foot section of the column.

Further analysis of the magnetic susceptibility data was performed to evaluate the relative amount of iron distributed beyond two feet for each test sample. The results, normalized to the amount of iron distributed by the control sample, are shown in Table 1.

TABLE 1
Relative amount of iron distributed further
than 2 feet, normalized to control.

| | Average MS reading in | Relative % Fe in |
|---|---|---|
| Sample | 2-4 foot section (SI) | 2-4 foot section |
| Column 1 (Control) | 1.05 × 10⁻³ | 100% |
| Column 2 (Invention) | 3.33 × 10⁻³ | 316% |
| Column 3 (Control + | 8.66 × 10⁻⁴ | 82% |
| glycerol) | | |

1. A liquid concentrate composition for remediation of groundwater, said composition consisting of:
30 to 50 wt % of zero-valent iron powder;
1 to 15 wt % of water;
0.1 to 1.5 wt % of a surfactant and
40 to less than 70 wt % of an organic carrier and optionally, n organic electron donor solution and/or remediation chemical,
wherein the organic electron donor solution and/or remediation chemical is not exceeding 10 wt % of the liquid concentrate.

2. The liquid concentrate according to claim 1, wherein the surfactant is anionic or nonionic surfactant.

3. The liquid concentrate according to claim 2, wherein the anionic surfactant is an alkali metal salt of a long-chain carboxyl or sulfonic acids.

4. The liquid concentrate according to claim 2, wherein the non-ionic surfactant is a sorbitan ethoxylate.

5. The liquid concentrate according to claim 1, wherein the organic carrier is selected from propylene glycol or glycerol.

6. The liquid concentrate according to claim 1, wherein the viscosity of the composition is between 2000 and 5000 cp as measured at 6 RPM with a Brookfield DV1 viscometer (spindle #2) at a temperature of 20 degrees C.

7. The liquid concentrate according to claim 1, wherein the gravity is about 1.8 fas determined by using a 83.2 mL BYK-Gardner PV-9654 specific gravity cup with 0.5% tolerance.

8. The liquid concentrate according to claim 1, wherein the iron particles in the dispersion have average diameter between 1 and 10 microns as measured by laser light scattering methods.

9. A method for preparation of a ready-to-use solution for injecting into the ground water with the purpose of remediation, said method comprising:
providing the liquid concentrate according to claim 1, diluting with water such that the final concentration of iron in the solution is between 0.1 wt % and 5 wt %.
